(19) United States
(12) Patent Application Publication
(10) Pub. No.: US 2006/0283717 A1
(43) Pub. Date: Dec. 21, 2006

(54) Method for the aftertreatment of a through hole of a component

(76) Inventors: Peter Bloch, Berlin (DE); Rene Jabado, Berlin (DE); Ursus Kruger, Berlin (DE); Daniel Kortvelyessy, Berlin (DE); Ralph Reiche, Belin (DE); Michael Rindler, Schoneiche (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/539,190

(22) PCT Filed: Dec. 11, 2003
(86) PCT No.: PCT/DE03/04095

§ 371 Date: Jul. 19, 2006

(30) Foreign Application Priority Data
Dec. 18, 2002 (DE) 102 59 366.3

(51) Int. Cl. B23H 5/00

(52) U.S. Cl. 205/666

(57) ABSTRACT

In prior art, through holes often have to be after-treated manually. Disclosed is a method allowing through holes to be after-treated in a chemical or electrochemical manner with the aid of a material-removing agent, the outer surface located around a discharge port of the through hole being protected accordingly from being attacked by the agent that is to be removed.

The invention relates to a process for remachining a through-hole in a component.

The desired geometry of through-holes in a component is often not achieved when producing the through-holes, which means that remachining is required. This situation may also arise if through-holes which are already present in the component are contaminated during a subsequent process as part of production of the component, for example by the through-hole being coated in an undesired way as a result of external coating of the component. It is also possible that the through-hole may become contaminated (oxidized) while the component is operating, meaning that it needs to be restored.

DE 34 03 402 C2 shows a process for the electrochemical machining of an outer surface of work pieces by means of an electrolyte. The machining of regions at the surface at which machining is undesirable is prevented by preventing the electrolyte from flowing into these regions by means of a counter-current of water, which requires a complex holding arrangement which has to be adapted to each component.

U.S. Pat. No. 5,702,288 discloses abrasive remachining of through-holes.

DE 198 32 767 A1 describes a method for cleaning a component in which the cleaning liquid flows through the through-holes and is also present in the desired way at all the other surfaces.

It is an object of the present invention to improve the remachining of through-holes.

The object is achieved by the process as claimed in claim 1.

The subclaims list further advantageous process steps. These process steps can advantageously be combined with one another in any desired way.

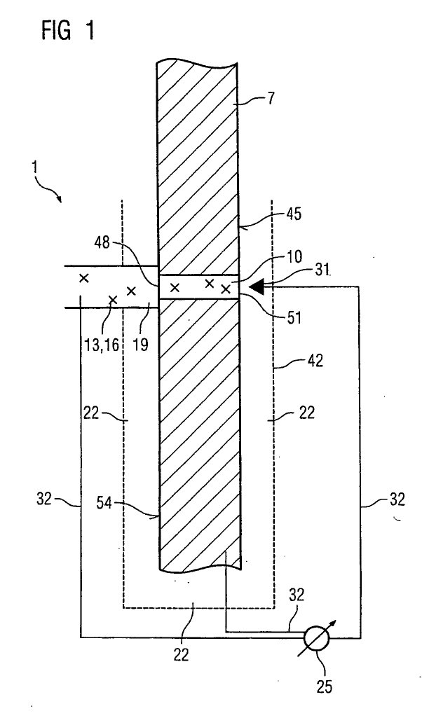

FIGS. 1, 2 and 3 each show an apparatus for carrying out a process according to the invention.

FIG. 1 shows an apparatus 1. A component 7, in particular a turbine blade or vane, with at least one through-hole 10, in particular a cooling-air hole, is arranged in the apparatus 1. By way of example, the component 7 has a cavity.

According to the invention, an agent 13 is passed through the through-hole 10 and removes material of the component 7 within the through-hole 10. The agent 13 is, for example, an electrolyte 16, and the material is removed electrolytically. The electrode 31 may be of various configurations. By way of example, it is matched to a respective exit opening 51 of the through-hole 10. The process can be used, for example, to machine a plurality of through-holes 10 simultaneously. Accordingly, by way of example, there are the same number of electrodes 31 and/or one or a pair of plate-like electrodes 31 arranged in the vicinity of the through-holes 10. A corresponding electrode 31 is arranged in the vicinity of the exit opening 51 of the through-hole 10. The component 7 and the electrode 31 are electrically conductively connected to a voltage/current source 25 via lines 32. This voltage/current source 25 is operated accordingly, in order to allow electrochemical removal of material. The component 7 represents the other electrode.

The current/voltage can be pulsed in order to improve the method. The current/voltage level, pulse shape, the pauses between the pulses, etc. can be varied as desired over the course of time in order to optimize the process parameters to the material which is to be removed.

The electrolyte 16 is supplied, for example, through an electrolyte feed 19, for example a hose, so that no material is removed from an inner side 54 of the component 7. Limited removal of material in the interior of the component 7 would also be permissible, provided that the wall thickness of the component 7 is not impaired, since it is primarily only the outer contours of the component 7 which should not be affected. By way of example, the electrolyte 16 flows through the entry opening 48 into the through-hole 10 and then flows out again through the exit opening 51. A different direction of flow is also conceivable. The electrolyte 16 is also, for example, electrically conductively connected to a voltage source 25 via a line 32, so that material is removed in the through-hole 10.

The component 7 is, for example, arranged in a medium 22 which does not attack an outer surface 45 of the component 7 and like the component 7 is located in a tank 42. The medium 22 is, for example, water or alcohol. The surface 45 is not prevented from coming into contact with the agent 13, 16 which emerges from the through-hole 10, but the dilution of the electrolyte 16 by the medium 22 means that there is little or no reaction between the electrolyte 16 and the surface 51 of the component 7. Consequently, the whole of the surface 45, i.e. not just the surface directly around the through-hole 10, is protected.

By way of example, the concentration of the electrolyte in the tank 42 is controlled in such a way that the electrolyte 16 does not attack the surface 45 at all.

The dilution is effected by immersing the component 7 in a medium 22 which does not attack the surface 45 of the component 7. This medium is, for example, water or alcohol.

Further possible ways of diluting the material-removing agent 13, 16 are conceivable. It is also possible for the outer surface 45 to be protected by masking at least around the through-hole 10.

Remachining is also required, for example, during MCrAlY coating of a high-temperature component (gas turbine components, turbine blade or vane), during which MCrAlY penetrates into the through-hole 10 in an undesired way and has to be removed again.

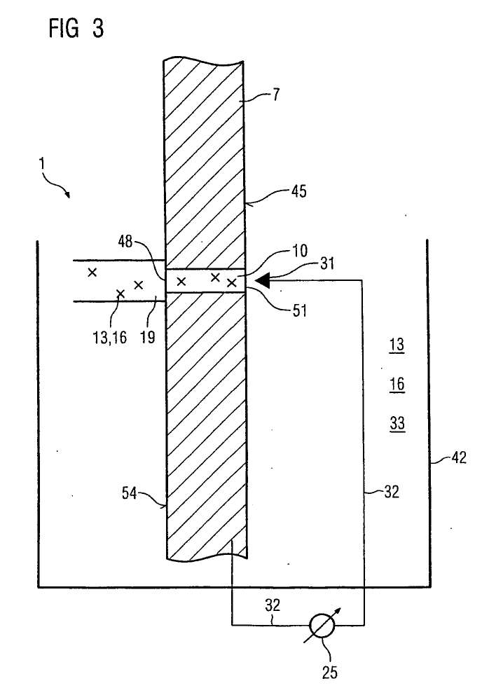

FIG. 3 shows a further apparatus 1 which can be used to carry out the process according to the invention.

In this case, the component 7 is arranged at least with its through-hole 10 in a tank 42 in such a way that the through-hole 10 is surrounded by the material-removing agent 13, 16 and 33 in the tank 42. However, the concentration or activity of the material-removing agent 13, 16, 33 is so low that the outer surface 45 of the component 7 is not attacked.

The component 7 is electrically connected to an electrode 31. Arranging the electrode 31 in the vicinity of the through-hole 10 ensures that material is only electrolytically removed locally, i.e. in the through-hole. The electrolytic removal only takes place after a voltage or a current has been applied. The electrode 31 is in this case, by way of example, of wedge-shaped design and projects slightly into the through-hole 10.

The material-removing agent 13, 16, 33 is pumped out of the tank 42 through the interior of the component 7 or from the outside through an electrolyte feed 19 and through the through-hole 10, for example by means of a pump (not shown), so that the material-removing agent 13, 16, 33 flows into the through-hole 10 from one side 54 or 51 and flows out on the other side 51 or 54, where the electrode 31 is present.

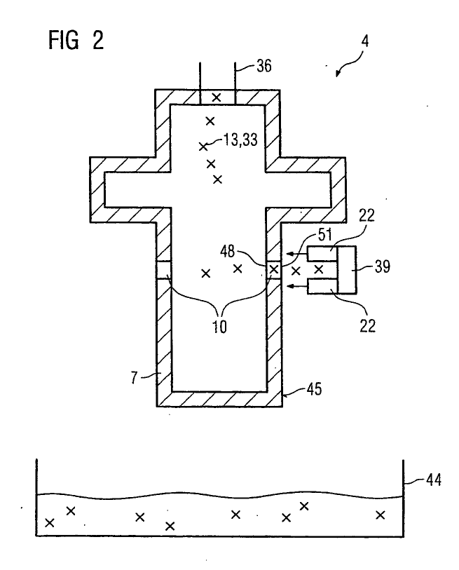

FIG. 2 shows, by way of example, a further apparatus 4 which can be used to carry out the process according to the invention.

In this case, an acid 33 (hydrochloric acid, nitric acid or acid mixtures), which is supplied via an acid feed 36 and flows through the through-holes 10 in the component 7, is used as the material-removing agent 13, which is preferably selected in such a way that it only attacks the material that is to be removed, but not the material of the substrate of the component 7. On the outer side 45 of the component 7 in the vicinity of the exit opening 51 there is, for example, a spray nozzle 39, which sprays a medium 22 which does not remove material around the through-hole 10 and dilutes the emerging acid 33, so that the surface 45, which is in the form, for example, of a coating on the substrate of the component 7, is not chemically attacked. In this way, the surface 45 is protected at least around the through-hole 10. The spray nozzle 39 is, for example, of suitable dimensions to spray medium 22 around a plurality of exit openings 51. It is likewise possible for the component 7 to be arranged in a tank 42 of water in order to effect dilution (FIG. 1).

1-9. (canceled)

10. A process for re-machining a through-hole in a component in which a material-removing agent flows through the through-hole and a surface arranged around the through-hole in the component is protected from removal of material by the material-removing agent, comprising:
protecting the surface by diluting the removing agent being after the removing agent emerges from the through-hole so that no material is removed at the surface by either the dilution of the removing agent which is effected by introducing the component having the through-hole to be machined into a medium that does not remove material, or the removing agent is diluted by spraying a medium which does not remove material around the emerging removing agent,
wherein water or alcohol is used as the medium which does not remove material.

11. The process as claimed in claim 10, wherein the surface is protected by an electrode arranged in the vicinity of the through-hole in such a way that material is removed only in the region in the vicinity of the through-hole.

12. The process as claimed in claim 10, wherein the material-removing agent flows through the through-hole from the inside outward.

13. The process as claimed in claim 10, wherein the removing agent is an acid.

14. The process as claimed in claim 10, wherein the removing agent is an electrolyte.

15. The process as claimed in claim 10, wherein the remachining is carried out electrolytically.

16. The process as claimed in claim 10, wherein the through-hole at least in part has a layer that needs to be removed.

17. The process as claimed in claim 10, wherein the surface is protected by a masking.

18. The process as claimed in claim 14, wherein a current/voltage is used to carry out the remachining electrolytically and the current/voltage is pulsed.
